(19) United States
(12) Patent Application Publication
(10) Pub. No.: US 2011/0100315 A1
(43) Pub. Date: May 5, 2011

(54) Intake manifold with integrated sound barrier

(75) Inventor: Kevin Vichinsky, Portage, MI (US)

(73) Assignee: MANN+HUMMEL GMBH, Ludwigsburg (DE)

(21) Appl. No.: 12/610,313

(22) Filed: Oct. 31, 2009

(51) Int. Cl. F02M 35/10; B21D 51/16

(52) U.S. Cl. 123/184.53; 123/184.61; 29/890.08

(57) ABSTRACT

Disclosed is a molded plastic intake manifold having an integrated sound barrier configured to reduce noise radiation through the walls of the intake manifold.

### TECHNICAL FIELD

This invention relates to intake air manifolds for internal combustion engines, air compressors and the like and, more particularly, to intake manifolds having an integrated sound barrier configured to reduce the transmission of noise and conversion of intake manifold structural vibration into radiated sound.

### BACKGROUND OF THE INVENTION

Internal combustion engines typically utilize an air induction and filter system to provide filtered combustion air to the engine. The air induction system typically includes an intake tract having an air filter to remove contaminants. Filtered air is delivered to the engine through an intake manifold. The intake manifold splits the air intake tract into one or more runners configured to provide intake air to the air intake valves at each cylinder of the engine.

Normal operation of the internal combustion engine may generate noise which enters the intake manifold such as due to pressure pulsations generated by the engine and synchronized to the opening and closing of engine intake valves. Known solutions include providing one or more resonators on an intake tract, each resonator configured to dampen a specific frequency. To dampen lower frequencies typically a larger resonator is require which is wasteful of vehicle under-hood space.

U.S. Pat. No. 6,155,122A4 discloses a noise silencer for reducing noise radiating from an air intake tract. A noise collection valve is provided in the communication passage. When sound pressure in the intake passage is positive, a noise collection valve opens the communication passage, communicating positive sound pressure to a noise accumulation room where it is discharged outside the intake system. The noise silencer reduces low-frequency noise in the intake passage.

Efforts to reduce vehicle component weight and reduce component cost have led to the replacement of metal intake tract components with lower cost and lighter weight plastic components. Due to the increased noise transmission through the housings of plastic air intake tract components, some applications have required the addition of separate and additional noise insulating acoustic cover components surrounding portions of the air intake components. Such covers are undesirable due to their added cost, additional space requirements, and because such covers may degrade, become detached or lost over extended periods of use.

In reducing radiated noise, it is particularly desired to reduce noise transmission through the walls of the intact manifold as this component is in close proximity to and directly connected to the engine and is exposed directly to engine valve operation and combustion generated noise. Plastic intake manifolds are known to transmit noise more readily than cast metal intake manifolds.

To reduce low frequency intake manifold noise, it is known to mold stiffening ribs onto the intake manifold housing and/or to improve housing stiffness by increasing the wall thickness and mass of the intake manifold. This technique becomes ineffective at higher frequencies.

As can be understood from the above, there remains a need in the art for a low cost, light weight molded intake manifold that is configured to reduce intake manifold noise, thereby eliminating the needs for separate noise insulating cover components.

### SUMMARY OF THE INVENTION

In one or more aspects of the invention, an air intake manifold includes a substantially air-tight manifold body configured to define an air passage therein for communicating intake combustion air into an engine. The manifold body includes a structurally stable outer body member with at least one sound absorbing inner body member arranged within the outer body member. At least one inlet port is provided in the air intake manifold and is in air flow communication with the air passage. Similarly at least one outlet port is provided in the intake manifold in air flow communication with the air passage.

In another aspect of the invention, the air intake manifold includes at least one runner member having a runner passage within. The runner member secured at a first end to the manifold body with the runner passages in communication with the manifold body passage. The runner members each have an outlet ports provided on an opposing second end of the runner member.

In another aspect of the invention, the intake manifold is manufactured using a two shot over-mold process.

In another aspect of the invention, the outer body is formed of an upper shell and a complimentary configured lower shell. The upper and lower shells are configured and adapted to closeably mate along complimentary edges. The shells are secured together along the complimentary edges to form the unitary manifold body.

In another aspect of the invention, the inner body comprises a foamed polypropylene material that covers at least a portion of an inner surface of the outer body.

In another aspect of the invention, the outer body member is made of an injection molded plastic resin including substantially tensilely inelastic fibers.

In another aspect of the invention, the fibers of the injection molded outer body member include any of: nylon fibers, glass fibers, metallic fibers and aramid fibers.

In another aspect of the invention, the outer body member is adapted for attenuating radiated intake manifold noise having a frequency of 700 Hz or less.

In another aspect of the invention, the inner body member is adapted for attenuating radiated intake manifold noise having a frequency of 1000 Hz of greater.

In another aspect of the invention, the sound absorbing inner body member is configured to mount to the interior of the outer body member by snap mounting into the outer body member.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 is a schematic sectional view of an intake manifold incorporating features of the present inventive disclosure;

FIG. 2A is a perspective view of the upper shell of another embodiment of an intake manifold incorporating features of the inventive disclosure presented herein; and

FIG. 2B is a perspective view of an intake manifold lower shell configured to mate with the upper shell of FIG. 2A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to air intake manifolds having an integrated sound attenuating barrier. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Noise radiated by an intake manifold may originate in a combination of engine vibration that excites the intake manifold walls as well as by noise that makes its way back through the intake runners from the engine. Engine noise may take the form of pressure pulsations transmitted back into the intake manifold in synchronization with the opening and closing of engine intake valves during engine operation. The vibration of the walls of the intake manifold under the influence of such pressure pulsations often results in a noise pattern that may be unpleasant to the driver, detracting from the otherwise smooth and audibly pleasing operation of the engine. Intake manifold noise may also detract from an observer's impression of “quality” of the vehicle.

To reduce the noise level radiated through the intake manifold, the intake manifold walls may be stiffened by the addition of stiffening ribs arranged on the exterior or interior walls of the intake manifold as well as by increasing the intake manifold wall thickness. Stiffening ribs and thicker walls can be effective in reducing intake manifold noise radiation at comparatively lower frequencies, for example: those between 0 to somewhere in the vicinity of 700 Hz. For frequencies above this range providing additional ribs to stiffen the intake manifold is relatively unproductive in reducing radiated sound levels.

An acoustic cover or “beauty cover” may be applied as an additional component over the intake manifold to effect an attenuation of intake manifold noise levels, such as higher frequency noise above the range where stiffening ribs are effective. (for example around 1000 HZ and higher)

The noise frequency ranges discussed are provided for comparative explanation purposes to improve general understanding of the objects of the invention and are to be interpreted in an explanatory and illustrative general sense rather than a more limiting definitive sense.

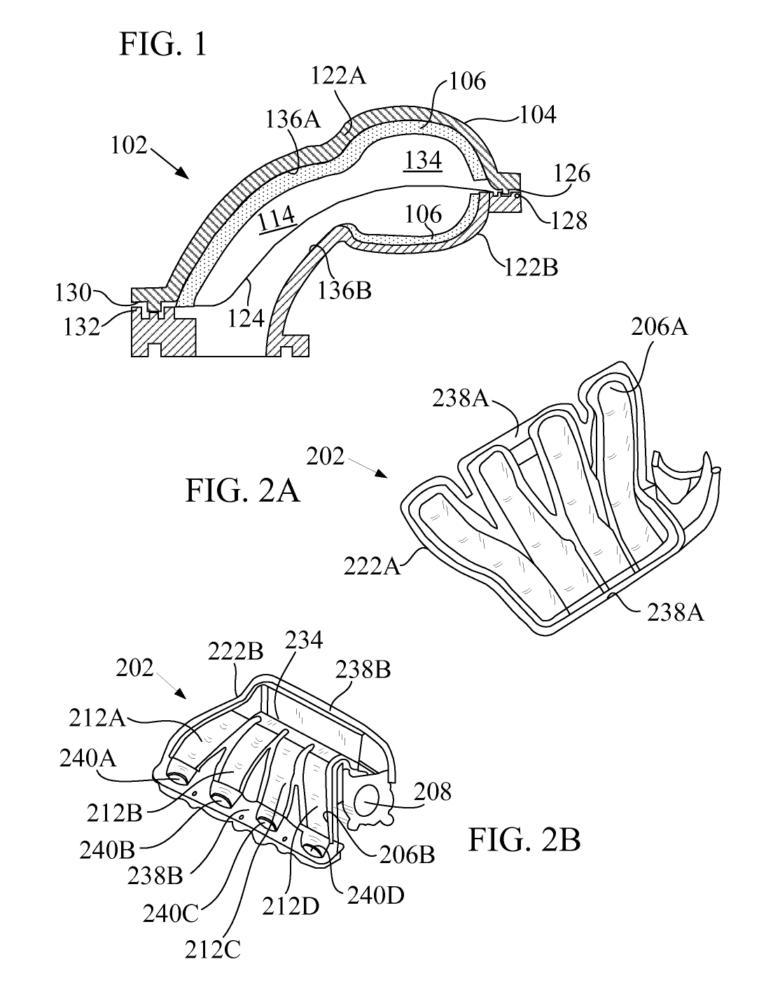

FIG. 1 is a schematic sectional view of one embodiment of an intake manifold with an integrated sound barrier incorporating features of the present inventive disclosure, showing the intake tract and a portion of one of the intake risers as would deliver air to the intake valves of the engine.

In the illustrated embodiment air intake manifold 102 has a structurally stable molded plastic outer body member 104 that is formed (at least in this illustrated and particular embodiment) in two halves, specifically an upper shell 122A and a lower shell 122B that are then welded, adhesive joined or otherwise secured tightly together to form a unitary air intake manifold 102. The upper 122A and lower 122B shells are cooperatively formed so that they may be mateably secured along cooperatively shaped edges 124 as well as along aligned mating flanges 126, 128 and 130, 132. Also shown is a body passage or air distribution chamber 134 configured to deliver filtered intake air to any of several intake runner passages, such as illustrated runner passage 114.

Although the embodiment of the intake manifold depicted in FIG. 1 is formed from two halve shell members 122A, 122B, intake manifolds according to the present inventive disclosure may be formed in one piece, or may be formed from separate multiple components (for one example—runners separate from manifold upper lower halves). With this in mind, the half-bodied embodiment illustrated in FIG. 1 is to be understood as exemplary but not limiting.

Continuing to refer to FIG. 1, the upper shell 122A and lower shell 122B half bodies of the outer body member 104 are preferably formed using a two shot plastic injection over-molding process, a molding process understood by those skilled in the art. In the two shot over-molding process, the outer body member portion of the shells are formed by injection molding of a thermoplastic resin in a first mold tool. The tool is then rotated to bring a second tool surface into position with the molded outer body and the inner body member is then molded onto selective portions of the inner surface of the outer body member portion of the shell using a foamed polypropylene or other suitable material configured to adsorb or attenuate sound energy within the air intake manifold 102. As different materials are typically used to form the inner body member and the outer body member, the outer body member may be provided with undercuts on the selective portions of the inner surface where the inner body is to be molded. The undercuts permit a portion of the inner body member to be captured by the undercuts during the molding process, thereby locking the inner body onto the outer shell and preventing the inner body from potentially detaching from the outer body.

The material of the outer body portion of the upper 122A and lower 122B shells is preferably a plastic resin containing substantially tensilely inelastic reinforcing fibers, the fibers adding structural stiffening and strength to the outer body. The use of a composite plastic resin permits the upper and lower shells to be vibration or heat welded together to form the unitary air intake manifold 102. It is known that the intake manifold may be subject to elevated pressures, for one example, if the engine were to backfire through the air intake valves into the intake manifold 102. The reinforcing fibers advantageously add sufficient structural strength to the outer body member 104 to resist such pressure surges as well as to assure the intake manifold meets the engine and/or vehicle manufacturer's burst test (pressure test) requirements.

Although the reinforcing fibers in the out body member 104 are preferably nylon fibers, the invention is not limited to the use of nylon reinforcing fibers as other types of substantially tensilely inelastic reinforcing fibers may also be used in the plastic injection molding process to achieve the invention. Examples of other suitable reinforcing fiber types include glass fibers, carbon fibers, metallic fibers and types of synthetic fibers such as, for example, aramid fibers.

In the two shot injection molding process, the upper 122A and lower 122B shells are formed by the injection molding process as discussed above. Then the sound attenuating inner body members 106 are then formed or arranged against portions of the interior walls 136A and 136B of the upper 122A and lower 122B shells and inner walls of the runners. It is envisioned that the sound attenuating inner body members 106 are advantageously arranged on interior wall portions of the inner body 106 where the presence of the additional sound attenuation contributes most productively to the desired reduction of intake manifold sound radiation. For one illustratory example, the sound attenuating inner body member(s) may be advantageously arranged against the interior wall of the upper intake manifold shell, upper portions of the intake manifold runners, and along portions of the intake manifold located nearest to the engine intake valves. Advantageously, other regions of the interior walls 136A and 136B may remain uncovered by the sound attenuating inner body member(s) 106, thereby reducing material requirements.

Preferably the sound attenuating member(s) 106 comprise a foamed polypropylene material arranged against or formed onto portions of the interior walls 136A and 136B, such as the interior walls surrounding the air distribution chamber and/or the runner passages 114. Preferably the foamed polypropylene material is formed on the interior walls utilizing the two shot injection molding process discussed earlier.

Preferably the air intake manifold including the integrated sound attenuation member(s) is produced in a single manufacturing step—two shot injection molding process, providing lower cost and removing the need to provide additional components outside the air intake manifold to reduce radiated noise. Alternately the sound attenuation members may be produced separately and installed into the intake manifold or manifold shells during a separate manufacturing step. In some embodiments the sound attenuation member may be configured to snap fit into the intake manifold. In other embodiments the sound attenuation members may be secured into the intake manifold using adhesive.

Advantageously, material usage and cost reductions are achievable in production of the outer body member 104 as less material is now required to stiffen and thicken the walls of the outer body member 104 due to the presence of the integrated sound attenuating inner body members 106.

Advantageously, the integrated sound attenuating inner body members 106 may be preferentially formed only over inner wall portions of the intake manifold and runners that are most problematic in transferring and radiating noise.

Advantageously, the sound attenuating inner body member or sound barrier reduces noise by absorbing sound energy. As discussed earlier, the intake manifold may be stiffened or thickened to reduce noise transmission through the intake manifold walls and reduce structural vibration of the walls (that also may result in radiated noise). However, providing only a relatively hard and stiff intake manifold wall tends not to reduce the sound level within the intake manifold, but rather tends to reflect sound energy internally in the intake manifold, thereby permitting the sound to travel further along the intake tract to a location where it may radiate out. Advantageously, the intake manifold with the integrated sound barrier of the present invention operates by absorbing a portion of the sound energy in the intake manifold and to this extent reduces reflected sound energy and the eventual displaced intake tract noise radiation.

An example of a foamed polypropylene sound attenuating material that has been identified as useful for the sound attenuating inner body 106 is an ethylene vinyl acetate copolymer containing polypropylene such as Exxon Ecorene™. Preferably the sound attenuating inner body is formed of a foamed polypropylene material where the foaming may be achieved by pressurized air induction into the inner body material or by a chemical reaction process effectively producing what may be called bubbles or voids in the walls of the sound attenuating inner body member(s). In some embodiments the sound attenuating inner body may also include reinforcing fibers such as nylon fibers, glass fibers, or metallic fibers to provide improved structural strength to the sound attenuating inner body 106.

Advantageously, the sound adsorption characteristics of the inner body member(s) 106 may be tuned by calibrating the density of the foamed polypropylene materials utilized, such as by control of the volume percent of voids in the inner body walls by control of the chemical or air induction foaming agents.

Advantageously, the foamed sound attenuating inner body member(s) 106 reduce radiated sound from the intake manifold 102 preferentially by adsorbing sound energy rather than by internal reflection of sound energy. Adsorption is preferred as reflected sound energy is free to travel along the intake system and radiate outwards at a location more susceptible to sound radiation.

Advantageously the wall thickness of the inner body member 106 may be intentionally varied over portions of the inner wall of the outer body member 104 to provide increased sound attenuation in those portions of the intake manifold 102 where it is most beneficial to achieve a reduction of overall intake manifold sound radiation or transmission.

FIG. 2A is a perspective view of the upper shell 222A of another embodiment of the inventive disclosure presented herein. FIG. 2B is a perspective view of a lower shell 222B, the shells 222A and 222B are configured and adapted to be mateably joined to form a unitary air intake manifold 202 having an integrated sound barrier. The sound barrier is provided by the sound attenuating inner body members 206A and 206B arranged onto portions of the inner walls of the upper shell 222A and lower shell 222B. The upper 222A an lower 222B shells have complimentary shaped joining closure surfaces 238A and 238B configured to enable the two shells to be welded or otherwise secured together to form a unitary air intake manifold 202. Also illustrated is the air distribution chamber 234 or body passage with four runner air passages 212A,B,C and 212D branching off. The air intake manifold 202 includes an air inlet port 208 in air flow communication with the air distribution chamber 234 and a plurality of outlet ports 240A,B,C and 240D in communication with the air distribution chamber 234 through the runner passages 212A,B,C, and 212D respectfully.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. An air intake manifold comprising:
a substantially air-tight manifold body defining an air passage therein, said body including:
a structurally stable outer body member;
at least one sound absorbing inner body member arranged within said outer body member;
at least one inlet port in air flow communication with said passage; and
at least one outlet port in air flow communication with said passage.

2. The air intake manifold according to claim 1, further comprising:
at least one runner member having a runner passage within, said runner member secured at a first end to said manifold body with said runner passages in communication with said body passage, said runner members having said outlet ports in communication with said runner passages and secured to a second end of said runner member.

3. The air intake manifold according to claim 1, wherein said intake manifold is manufactured using a two shot over-mold process.

4. The air intake manifold according to claim 2, wherein outer body comprises:
an upper shell; and
a complimentary lower shell, said shells configured and adapted to closeably mate along complimentary edges, said shells secured together along said complimentary edges to form said manifold body.

5. The air intake manifold according to claim 4, wherein said inner body comprises a foamed polypropylene material covering at least a portion of an inner surface of said outer body.

6. The air intake manifold according to claim 5, wherein said outer body member compromises injection molded plastic resin including substantially tensilely inelastic fibers.

7. The air intake manifold according to claim 6, wherein said fibers comprise any of: nylon fibers, glass fibers, metallic fibers and aramid fibers.

8. The air intake manifold according to claim 6, wherein said outer body member is adapted for attenuating radiated intake manifold noise having a frequency of 700 Hz or less.

9. The air intake manifold according to claim 6, wherein said inner body member is adapted for attenuating radiated intake manifold noise having a frequency of 1000 Hz of greater.

10. The air intake manifold according to claim 1 wherein said sound absorbing inner body member is configured to snap into said outer body member.
